(19) United States
(12) Patent Application Publication
(10) Pub. No.: US 2025/0052938 A1
(43) Pub. Date: Feb. 13, 2025

(54) OPTICAL POLARIZING DEVICE AND MANUFACTURING METHOD THEREFOR, AND NEAR-EYE DISPLAY APPARATUS

(71) Applicant: Beijing Zitiao Network Technology Co., Ltd., Beijing (CN)

(72) Inventors: Shaopeng ZHU, Beijing (CN); Wei ZHANG, Beijing (CN); Ziyang ZHANG, Beijing (CN); Zhao ZHANG, Beijing (CN); Xiaokai LI, Beijing (CN)

(21) Appl. No.: 18/718,329

(22) PCT Filed: Apr. 11, 2023
(86) PCT No.: PCT/CN2023/087651

§ 371 Date: Jun. 10, 2024

(30) Foreign Application Priority Data
Apr. 28, 2022 (CN) 202210470197.X

(51) Int. Cl. G02B 5/30; G02B 1/08

(52) U.S. Cl. CPC G02B 5/3083; G02B 1/08

(57) ABSTRACT

The present disclosure provides an optical polarizing device and a manufacturing method therefor, and a near-eye display apparatus. The optical polarizing device includes: a reflective polarizing film, a linear polarizing coating located on one side of the reflective polarizing film, and a phase retardation coating located on the other side of the reflective polarizing film. A distance between at least one of the linear polarizing coating and the phase retardation coating and a surface of the reflective polarizing film is less than 0.5 micrometers.

### CROSS-REFERENCE TO RELATED APPLICATION

The present application claims priority to the Chinese Patent Application No. 202210470197.X filed on Apr. 28, 2022, the content of which is incorporated herein in its entirety as a part of the present application.

### TECHNICAL FIELD

The present disclosure relates to an optical polarizing device and a manufacturing method therefor, and a near-eye display apparatus.

### BACKGROUND

In a virtual reality (VR) device, a near-eye display apparatus magnifies images displayed on a display screen through a lens, imparting a viewer an immersive experience. At present, the lenses of mainstream technology include Fresnel lenses and ultra-short-throw folded-optical-path (pancake) lenses. The pancake lens greatly reduces the required distance between the near-eye display apparatus and the human eye based on a folded optical path, thereby making the VR device thinner and lighter.

### SUMMARY

According to some embodiments of the present disclosure, there is provided an optical polarizing device, including: a reflective polarizing film; a linear polarizing coating located on one side of the reflective polarizing film; and a phase retardation coating located on the other side of the reflective polarizing film, wherein a distance between at least one of the linear polarizing coating and the phase retardation coating and a surface of the reflective polarizing film is less than 0.5 micrometers.

In some examples, the at least one of the linear polarizing coating and the phase retardation coating is in direct contact with the surface of the reflective polarizing film.

In some examples, a continuous intermediate layer with a thickness less than 0.5 micrometers is provided between the at least one of the linear polarizing coating and the phase retardation coating and the surface of the reflective polarizing film.

In some examples, an intermediate layer including a plurality of discretely distributed island structures is provided between the at least one of the linear polarizing coating and the phase retardation coating and the surface of the reflective polarizing film, and the at least one of the linear polarizing coating and the phase retardation coating is in direct contact with the surface of the reflective polarizing film between the plurality of island structures.

In some examples, the linear polarizing coating has a thickness of 0.5 to 10 micrometers.

In some examples, an angle between an optical axis of the linear polarizing coating and one of optical axes of the reflective polarizing film is less than 5 degrees so as to enable polarized light transmitted through the reflective polarizing film to be transmitted through the linear polarizing coating.

In some examples, the linear polarizing coating includes a regularly arrangeable first repeating component and a dichroic second repeating component on the surface of the reflective polarizing film.

In some examples, the first repeating component and the second repeating component each include at least one of a molecule, a molecular fragment and a group.

In some examples, the first repeating component includes a lyotropic liquid crystal molecule, a molecular fragment or a group, and the second repeating component includes at least one of iodine, an azo dye, a polycyclic dye, an anthraquinone dye, triphenyldiazine and a derivative thereof, and monomethine and polymethine compounds.

In some examples, the first repeating component and the second repeating component are two molecular fragments of one molecule.

In some examples, the order parameter of the regularly arrangeable first repeating component is greater than 0.6.

In some examples, the phase retardation coating has a thickness of 0.5 to 10 micrometers.

In some examples, the phase retardation coating includes a regularly arrangeable third repeating component on the surface of the reflective polarizing film, and the third repeating component has a refractive index anisotropy.

In some examples, the phase retardation coating is a quarter-wave phase retardation coating.

In some examples, the phase retardation coating has a first axial direction exhibiting the highest refractive index and a second axial direction exhibiting the lowest refractive index in a plane where the phase retardation coating is located, and the phase difference between the first axial direction and the second axial direction is 90 to 190 nanometers. In some other examples, the phase difference between the first axial direction and the second axial direction is 100 to 175 nanometers.

In some examples, the order parameter of the regularly arrangeable third repeating component is greater than 0.6.

In some examples, the optical polarizing device further includes a transparent protective layer formed on at least one of a side of the linear polarizing coating away from the reflective polarizing film, and a side of the phase retardation coating away from the reflective polarizing film.

According to some embodiments of the present disclosure, there is provided a method for fabricating an optical polarizing device, the method including: preparing a reflective polarizing film; forming a linear polarizing coating on a surface of a first side of the reflective polarizing film; and forming a phase retardation coating on a surface of a second side of the reflective polarizing film opposite to the first side, wherein a distance between at least one of the linear polarizing coating and the phase retardation coating and a surface of the reflective polarizing film is less than 0.5 micrometers.

In some examples, the above method further includes at least one of the following steps: prior to forming the linear polarizing coating, forming, on the surface of the first side of the reflective polarizing film, a first intermediate layer that has a thickness less than 0.5 micrometers or is in the form of discretely distributed islands; and prior to forming the phase retardation coating, forming, on the surface of the second side of the reflective polarizing film, a second intermediate layer that has a thickness less than 0.5 micrometers or is in the form of discretely distributed islands.

In some examples, forming the linear polarizing coating includes: dissolving, in a liquid solvent, a first repeating component capable of forming a liquid crystal phase and a dichroic second repeating component to form a first coating solution; coating the surface of the first side of the reflective polarizing film with the first coating solution; and removing the liquid solvent, and causing the first repeating component and the second repeating component to be regularly arranged to form the linear polarizing coating.

In some examples, forming the phase retardation coating includes: dissolving, in a liquid solvent, a compound capable of forming a third repeating component that has a refractive index anisotropy to form a second coating solution; coating the surface of the second side of the reflective polarizing film with the second coating solution; and removing the liquid solvent, and forming the third repeating component in a regular arrangement to form the phase retardation coating.

According to some embodiments of the present disclosure, there is provided a near-eye display apparatus, including: a display device, and an optical component arranged on a light-exiting side of the display device, wherein the optical component includes at least one lens and an optical polarizing device formed on a surface of the at least one lens, the optical polarizing device being an optical polarizing device according to any one of the above examples.

In some examples, the surface of the at least one lens that is provided with the optical polarizing device is a curved surface.

### BRIEF DESCRIPTION OF DRAWINGS

In order to illustrate the technical solutions of the embodiments of the present invention more clearly, the drawings of the embodiments will be briefly introduced below. Obviously, the drawings in the following description only relate to some embodiments of the present invention, and are not intended to limit the present invention.

FIG. 1 is a schematic diagram of a structure of a virtual reality (VR) display device;

FIG. 2 is a schematic diagram of a cross section of a composite film;

FIG. 3 is a schematic diagram of a cross section of an optical polarizing device according to some embodiments of the present disclosure;

FIG. 4 is a schematic diagram of a cross section of an optical polarizing device according to some embodiments of the present disclosure;

FIG. 5 is a schematic diagram of a cross section of an optical polarizing device according to some embodiments of the present disclosure;

FIG. 6 is a schematic diagram of a structure of a near-eye display apparatus according to some embodiments of the present disclosure; and

FIG. 7 is a schematic diagram of a structure of another near-eye display apparatus according to some embodiments of the present disclosure.

### DETAILED DESCRIPTION

In order to make the objects, technical solutions and advantages of embodiments of the present invention clearer, the technical solutions in the embodiments of the present invention will be clearly and completely described below with reference to the drawings of the embodiments of the present invention. Apparently, the described embodiments are some rather than all of the embodiments of the present invention. Based on the described embodiments of the present invention, all other embodiments obtained by those of ordinary skill in the art without involving any inventive effort fall within the scope of protection of the present invention.

Unless defined otherwise, the technical or scientific terms used herein shall have the common meanings as understood by those of ordinary skill in the art to which the present invention belongs. The terms “first”, “second” and the like used in the description and the claims of the patent application of the present invention do not denote any order, quantity or importance, but are only used to distinguish different components. Likewise, the word “a”, “an” or the like does not indicate a quantitative limit, but rather indicates the presence of at least one item.

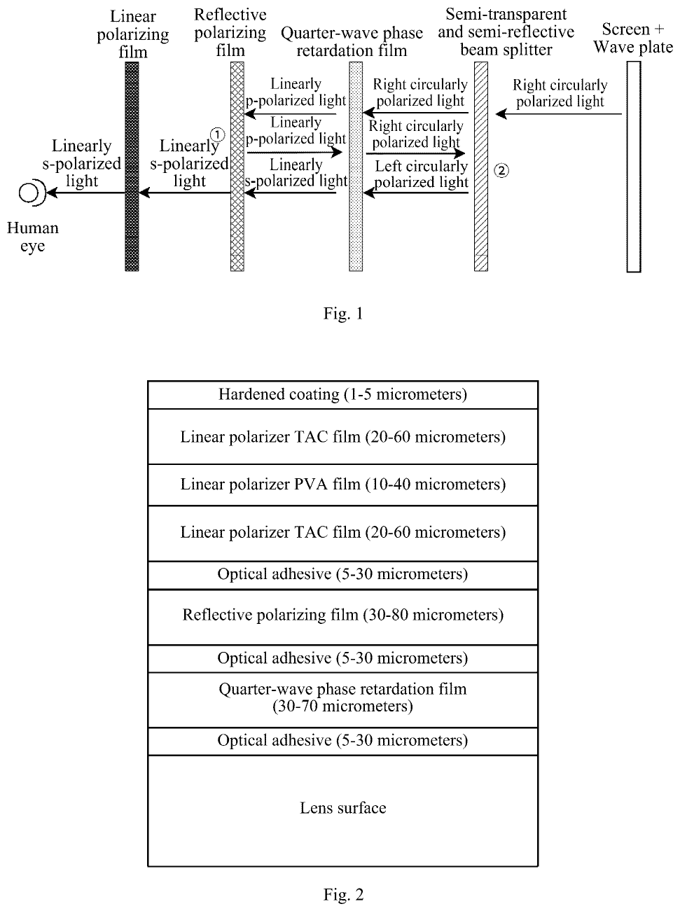

In a virtual reality (VR) device, the use of a folded optical path can greatly shorten the distance between the human eye and a screen, making the VR device thinner and lighter. FIG. 1 shows a schematic diagram of a structure of a VR display device. The VR display device shown in FIG. 1 includes a folded-optical-path (pancake) lens. The optical components in the folded optical path mainly include, from the screen to the human eye, a semi-transparent and semi-reflective beam splitter, a quarter-wave phase retardation film, a reflective polarizing film and a linear polarizing film. Among these optical functional films, the quarter-wave phase retardation film is configured to convert the polarized state of light from circularly polarized light into linearly polarized light or from linearly polarized light into circularly polarized light. The reflective polarizing film has the function of allowing transmission of polarized light in one direction (e.g., linearly s-polarized light) and reflecting polarized light in another direction (e.g., linearly p-polarized light). The linear polarizing film is configured to further filter out other stray light and only allow the polarized light transmitted through the reflective polarizing film (e.g., the linearly s-polarized light) to enter the human eye. The latter three of these optical functional films (i.e., the quarter-wave phase retardation film, the reflective polarizing film and the linear polarizing film) form a folded-optical-path polarizing device, also referred to as a composite film.

The folded-optical-path polarizing device is operated based on the principles as follows. Right circularly polarized light is emitted from a surface of the screen cooperating with a wave plate, and then passes through the semi-transparent and semi-reflective beam splitter, with its polarized state remaining unchanged. After the light further passes through the quarter-wave phase retardation film, the right circularly polarized light is converted into linearly polarized light in direction p (linearly p-polarized light). In FIG. 1, \textcircled{1} represents the first reflection of light, which occurs on a surface of the reflective polarizing film. In this example, the reflective polarizing film reflects linearly p-polarized light and allows transmission of linearly s-polarized light. The linearly p-polarized light is reflected and then passes through the quarter phase retardation film, and is converted back into right circularly polarized light. In FIG. 1, \textcircled{2} represents the second reflection of light, which occurs on a surface of the semi-transparent and semi-reflective beam splitter. Due to half-wave loss, the reflected light is converted from right circularly polarized light to left circularly polarized light. The left circularly polarized light is then transmitted through the quarter phase retardation film, and is converted into linearly s-polarized light, which can be transmitted through the reflective polarizing film and further filtered by the linear polarizing film to remove stray light before entering the human eye. The semi-transparent and semi-reflective beam splitter has a curvature, and the original focal length of the lens is folded due to the above two reflections, thereby greatly compressing the space required between the human eye and the near-eye display apparatus.

The polarizing device composite film formed by the quarter-wave phase retardation film, the reflective polarizing film and the linear polarizing film as described above is made of three separate plastic films bonded by a transparent adhesive, that is, forming a “three-in-one” film, and the composite film is attached to a lens surface. In some examples, in order to achieve better optical effects and durability, a plastic film with a hardened/anti-reflective coating is further bonded to a surface of the composite film to form a “four-in-one” film, and even a composite film in which more functional films are bonded and stacked.

FIG. 2 is a schematic diagram of a cross section of the composite film described above. As shown in FIG. 2, the quarter-wave phase retardation film, the reflective polarizing film and the linear polarizing film are sequentially attached to the lens surface. An optical adhesive of 5 to 30 micrometers is provided between the above film layers or between the film layer and the lens surface to ensure the attachment property, etc. In addition, since the film layers are separate film layers before the attachment, each film layer also has a certain thickness to ensure mechanical properties or to enable an attachment treatment operation, etc. For example, the quarter-wave phase retardation film has a thickness of 30 to 70 micrometers. For example, the quarter phase retardation film may be made of modified polycarbonate, or may be made of stretched cyclic olefin polymer (COP), etc. For example, the reflective polarizing film has a thickness of 30 to 80 micrometers. The reflective polarizing film may be formed by a multi-layer co-extruded polyester film, or may be formed by means of wire grid micro-fabrication technology such as nanoimprint lithography. For example, the linear polarizing film is formed of a sandwich structure with a treated polyvinyl alcohol (PVA) film of 10 to 40 micrometers sandwiched between two layers of cellulose triacetate (TAC) film of 20 to 60 micrometers, and implements polarized absorption by means of strongly stretched PVA impregnated with iodine or a dye. In addition, it is also possible to provide a hardened coating of 1 to 5 micrometers on the surface of the linear polarizing film to provide protection.

However, the inventors of the present disclosure have found that the composite film formed by separate plastic films stacked using a transparent adhesive as described above has some defects. For example, the above composite film is formed by at least three optical films bonded together, with an optical adhesive being provided between adjacent films, so that a large number of optical interfaces are formed, each of which reflects and scatters light, causing stray light that affects the imaging. The above composite film has a low processing yield. The composite film needs to undergo a procedure of repeatedly applying an optical adhesive and bonding, which results in many process stations, a long process flow, and many parameters that need to be controlled, and is easy to cause problems in terms of the alignment of orientation of the optical film, wrinkles in the film, non-uniform optical adhesive, uneven bonding, contaminations due to repeated processing, affecting the product yield. In addition, the composite film has low reliability, and the composite film formed by means of bonding is prone to layer separation due to failure of the optical adhesive under the action of external loads (such as temperature and chemicals). If such a composite film is used, the lens has a low freedom of deign. In some pancake lens designs, it is necessary to bond a composite film to a curved surface to achieve excellent imaging performance, and the bonding process requires heating. However, the composite film has an excessive overall thickness, and the layers thereof have significantly different mechanical and thermal properties, making it difficult to bond to a curved surface. Furthermore, the composite film uses a conventional linear polarizing film, which has a structure in which a layer of treated polyvinyl alcohol (PVA) material is sandwiched between two layers of transparent plastic film, and has poor heat and moisture resistances. Therefore, the bonding-type composite film can only be bonded to a flat surface, significantly affecting the freedom of design of the lens.

According to an embodiment of the present disclosure, there is provided an optical polarizing device, including: a reflective polarizing film; a linear polarizing coating located on one side of the reflective polarizing film; and a phase retardation coating located on the other side of the reflective polarizing film, where a distance between at least one of the linear polarizing coating and the phase retardation coating and a surface of the reflective polarizing film is less than 0.5 micrometers. According to the embodiment of the present disclosure, each of the linear polarizing coating and the phase retardation coating is formed, directly or via an intermediate layer with a thickness less than 0.5 micrometers, on the reflective polarizing film, such that the formed optical polarizing device is thin, has few (or no) adhesive layers, is heat-resistant, and adapts to be bonded to a curved surface, thereby greatly improving the freedom of design of a folded-optical-path near-eye display lens.

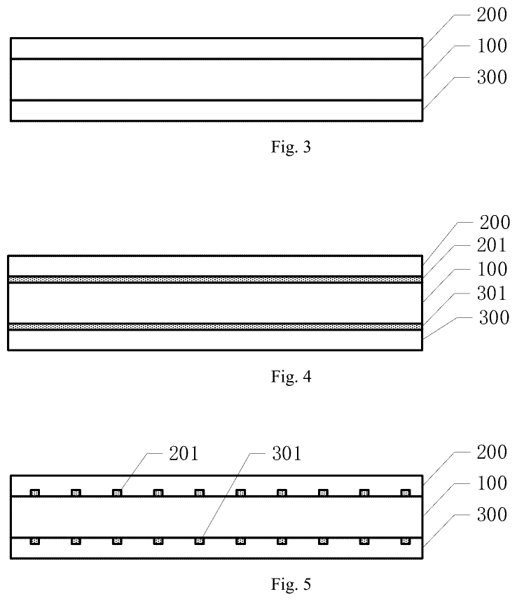

FIG. 3 is a schematic diagram of a cross section of an optical polarizing device according to some embodiments of the present disclosure. As shown in FIG. 3, the optical polarizing device includes a reflective polarizing film 100, and a linear polarizing coating 200 and a phase retardation coating 300 which are located on two sides of the reflective polarizing film 100. For example, the linear polarizing coating 200 and the phase retardation coating 300 are directly formed on two opposing surfaces of the reflective polarizing film 100 respectively using materials for forming the linear polarizing coating 200 and the phase retardation coating 300. For example, in this embodiment, a surface of the linear polarizing coating 200 facing the reflective polarizing film 100 is in direct contact with one of the surfaces of the reflective polarizing film 100; and a surface of the phase retardation coating 300 facing the reflective polarizing film 100 is in direct contact with the other surface of the reflective polarizing film.

The optical polarizing device according to some embodiments of the present disclosure may be used in a folded optical path, for example, in a folded optical path of a near-eye display apparatus, and serves as a folded-optical-path polarizing device.

In some embodiments, the reflective polarizing film (also referred to as a polarizing beam-splitting film) has the following properties: there is one optical axis direction on a film plane, and the transmittance of a polarized component of the incident light parallel to this direction (parallel transmittance) is greater than 80%. In some examples, the parallel transmittance is greater than 85%. At the same time, the reflectance of this component (parallel reflectance) is less than 5%. In some examples, this parallel reflectance is less than 1%. The transmittance of the polarized component of the incident light perpendicular to this direction (orthogonal transmittance) is less than 0.5%. In some examples, the orthogonal transmittance is less than 0.1%. At the same time, the reflectance of this component (orthogonal reflectance) is greater than 80%. In some examples, the orthogonal reflectance is greater than 85%. For example, the reflective polarizing film may be a plastic reflective film with a thickness of, for example, 30 to 200 micrometers. In some examples, the reflective polarizing film may have a thickness of 30 to 80 micrometers. The reflective polarizing film may be made of a multi-layer co-extruded polyester film, or may be made of a metal wire grid formed on a plastic film substrate (cellulose triacetate (TAC), cyclic olefin polymer (COP), cyclic olefin copolymer (COC), polymethyl methacrylate (PMMA), etc.) and its surface by means of micro-nano fabrication, or may be made of cholesteric liquid crystal in a desired arrangement on the plastic film substrate and its surface. For example, the reflective polarizing film may be Image Quality Polarizer Enhanced (3M IQPE) from 3M company or WGF from Asahi Kasei Corporation. According to the embodiments of the present disclosure, there are no particular limitations on the material or form of the reflective polarizing film, and any reflective polarizing film that meets the required optical and mechanical properties can be used.

For example, on the film plane of the reflective polarizing film, there are two optical axis directions, in one of the optical axis directions the linearly s-polarized light is reflected while the linearly p-polarized light transmits, and in the other optical axis direction, the linearly p-polarized light is reflected while the linearly s-polarized light transmits.

The linear polarizing coating 200 is used to filter light and only allows transmission of polarized light in a specific polarization direction. For example, the linear polarizing coating 200 has a polarized absorption property, that is, there is one optical axis direction parallel to its surface. The transmittance of the coating to the polarized light parallel to the optical axis direction is much greater than the transmittance to the polarized light perpendicular to this direction, and the absorptance to the polarized light perpendicular to the optical axis direction is much greater than the absorptance to the polarized light parallel to the optical axis direction.

For example, the linear polarizing coating has a thickness of 0.5 to 10 micrometers. In some examples, the linear polarizing coating has a thickness of 0.5 to 2 micrometers.

In some examples, the performance indicator of the linear polarizing coating 200 satisfies the degree of polarization of greater than 99%. In some examples, the degree of polarization is greater than 99.5%. For example, the linear polarizing coating 200 has a single transmittance of greater than 35%, a parallel transmittance of greater than 25%, and an orthogonal transmittance of less than 0.1%. The optical axis direction of the linear polarizing coating 200 is consistent with one of the optical axis directions of the reflective polarizing film, such that the polarized light transmitted through the reflective polarizing film can be transmitted through the linear polarizing coating. For example, the optical axis direction of the linear polarizing coating 200 being consistent with one of the optical axis directions of the reflective polarizing film means that the angle between them is less than 5°. In some examples, the angle between them is less than 2°. In some examples, the optical axis direction of the linear polarizing coating 200 and one of the optical axis directions of the reflective polarizing film are parallel to each other.

For example, the main components of the linear polarizing coating 200 include: a regularly arrangeable repeating component (also referred to as a first repeating component) and a dichroic repeating component (also referred to as a second repeating component). For example, the regularly arrangeable repeating component refers to a repeating component that can be regularly arranged under certain conditions, and may be, for example, a substance with a liquid crystal phase. The regularly arrangeable repeating component may have a function of guiding the arrangement of the dichroic repeating component. For example, the regularly arrangeable repeating component may be a molecule, a molecular fragment or a group. In some examples, the regularly arrangeable repeating component is a lyotropic liquid crystal molecule, molecular fragment or group. After the linear polarizing coating 200 is formed, the repeating component is uniformly distributed throughout the coating and is regularly arranged. For example, the degree of regularity is represented as order parameter S, satisfying S>0.6, and further, S>0.8.

The dichroic repeating component may be, for example, a molecule, a molecular fragment or a group. For example, the dichroic repeating component may be iodine, an azo dye, a polycyclic dye, an anthraquinone dye, a triphenyldiazine and its derivatives, monomethine and polymethine compounds, etc. The dichroic ratio of the dichroic repeating component, i.e., the ratio D of the absorptance of the molecule to the polarized light perpendicular to the direction exhibiting the maximum absorption to the absorptance of the molecule to the polarized light parallel to the direction exhibiting the maximum absorption, satisfies D>7.

For example, the regularly arrangeable repeating component and the dichroic repeating component may be respectively formed by molecules, molecular fragments or groups separated from each other, or may be respectively two molecular fragments of one molecule, as long as the above conditions of regular arrangement and dichroism can be satisfied. This is not particularly limited in the embodiments of the present disclosure. For example, it is possible to obtain the optimal configuration of conditions according to adjustments of process conditions and a proportion of formulation during fabrication of the linear polarizing coating, so as to allow the dichroic molecules, molecular fragments or groups to be regularly arranged with the liquid crystal phase, thereby macroscopically exhibiting the linearly polarized absorption properties described above. In some examples, sulfonated polycyclic dye molecules are in a regular arrangement in the linear polarizing coating, and such molecule includes both molecular fragments that can form a liquid crystal phase and dichroic molecular fragments. In some other examples, highly dichroic iodine molecules are arranged along the regular arrangement of the lyotropic liquid crystal molecules.

In some examples, the linear polarizing coating may be formed by dissolving a first repeating component and a second repeating component in a liquid solvent (e.g., one of water, alcohols, ethers, ketones, etc., or a mixture thereof), and by means of slit coating, allowing a coating head to travel on a surface of the reflective polarizing film from one end to the other end, while coating the surface of the reflective polarizing film with the solution. During this procedure, the first repeating component in the solution is regularly arranged in the direction of travel of the coating head, which also constrains the dichroic component (the second repeating component) to be regularly arranged in its arrangement direction. Subsequently, heating is performed to evaporate the solvent, thus forming a linear polarizing coating 200.

In some examples, before the linear polarizing coating 200 is formed, the surface of the reflective polarizing film 100 may also be subjected to plasma treatment or corona treatment to enhance the adhesion of the linear polarizing coating 200 to the reflective polarizing film 100 or to promote the regular arrangement of the first repeating component.

In some examples, external constraints such as linearly polarized light or an electric field may be applied during the formation of the linear polarizing coating 200 to promote the regular arrangement of the first repeating component.

In some examples, after the linear polarizing coating 200 is formed, at least one layer of transparent coating may be further formed on the surface of the linear polarizing coating 200 (not shown). The transparent coating can protect the linear polarizing coating 200 from scratches, isolate it from external moisture and chemicals, reduce surface reflection, etc. The transparent coating may be formed by wet coating, for example, by means of slit coating, wire bar coating, blade coating, micro-gravure coating, spin coating, etc. For example, the transparent coating may be an acrylic coating, an ultraviolet-curable coating, a low-refractive-index coating, a fluorine-containing nano-coating, etc.

As can be known from the above description, the substance in the linear polarizing coating 200 responsible for the optical function is primarily the dichroic repeating component, and the regular arrangement of the dichroic repeating component is influenced by the regularly arrangeable repeating component such as liquid crystal phase molecules. The desired optical functions can be achieved by directly coating the reflective polarizing film with the linear polarizing coating 200, without the need for attaching separately formed thicker linear polarizers by means of an optical adhesive. In addition, since the linear polarizing coating is used in the embodiments of the present disclosure, it is possible to avoid using a polyvinyl alcohol (PVA) material with poor heat resistance that is used in linear polarizers in the prior art.

The phase retardation coating 300 is formed on a side of the reflective polarizing film 100 opposite to the side on which the linear polarizing coating 200 is formed, that is, on a side different from the side on which the linear polarizing coating 200 is located.

In some examples, the phase retardation coating 300 has a thickness of 0.5 to 10 micrometers. For example, the phase retardation coating 300 has a thickness of 1 to 5 micrometers.

Assuming that the phase retardation coating 300 is present separately, its in-plane phase difference R0 (at wavelength 550 nm) is in a range from 90 to 190 nm, or for example from 120 to 170 nm, or for example from 140 to 150 nm. The phase retardation coating 300 has both an axial direction exhibiting the highest refractive index and an axial direction exhibiting the lowest refractive index along the X-Y plane where its surface is located. In some examples, the axial direction exhibiting the highest refractive index or the axial direction exhibiting the lowest refractive index of the phase retardation coating 300 is at an angle of 45° with one of the optical axis directions of the reflective polarizing film. For example, the phase retardation coating 300 is configured to switch the transmitted light between a circularly polarized state and a linearly polarized state.

For example, the phase retardation coating 300 is a quarter-wave phase retardation coating.

The phase retardation coating 300 includes at least one repeating component (also referred to as a third repeating component) regularly arranged and uniformly distributed throughout the coating, and the third repeating component may be a molecule, a molecular fragment or a group. Each single third repeating component has a refractive index anisotropy, and has a birefringence Δ>0.1. In some examples, Δ>0.3. For example, the third repeating component is a rod-like lyotropic liquid crystal molecule, with a length-width ratio being greater than 3.

For example, the third repeating component is uniformly distributed throughout the coating and is regularly arranged, with the degree of regularity represented as the order parameter S, satisfying S >0.6. In some examples, S >0.8.

In some examples, the phase retardation coating 300 may be formed by the following method. Birefringent lyotropic liquid crystal molecules, such as polyamide molecules with sulfonic groups or carboxyl groups or their metal salts, polyxylene sulfonic acid and its metal salts, and imidazoquinolines with sulfonic groups or carboxyl groups or their metal salts, are dispersed in water or in an alcohol solvent; and on the surface of the reflective polarizing film, by means of slit coating, wire bar coating, micro-gravure coating, metering bar coating, etc., in a predetermined coating direction, the solution is applied on the surface of the reflective polarizing film from one end to the other end, while regularly arranging the liquid crystal molecules in the solution along the application direction. Heating is performed to evaporate the solvent, thus forming the phase retardation coating 300.

In some examples, similar to the formation of the linear polarizing coating 200 described above, the surface of the reflective polarizing film 100 may also be subjected to plasma treatment or corona treatment before the phase retardation coating is formed, so as to enhance the adhesion between the phase retardation coating 300 and the reflective polarizing film 100 or to promote the regular arrangement of the third repeating component. In some examples, external constraints such as linearly polarized light or an electric field may also be applied during the formation of the phase retardation coating to promote the regular arrangement of the third repeating component. For example, it is possible to obtain the optimal configuration of conditions by adjusting the process conditions and the proportion of formulation to allow the birefringent repeating component to be regularly arranged and to allow the axial direction exhibiting the highest refractive index (slow axis) or the axial direction exhibiting the lowest refractive index (fast axis) to be at 45° with one of the optical axis directions of the reflective polarizing film 100, thereby macroscopically exhibiting the quarter phase retardation properties or broadband quarter phase retardation properties.

In other examples, the phase retardation coating 300 may be formed by the following method. A solution containing lyotropic liquid crystal molecules is applied by means of slit coating, wire bar coating, micro-gravure coating, metering bar coating, etc., and the solvent is evaporated, such that a first layer of first phase retardation coating in which the repeating component is regularly arranged and is uniformly distributed throughout the coating is formed at a specific angle; and then, using a different formulation of lyotropic liquid crystal solution, a second layer of second phase retardation coating in which the repeating component is regularly arranged and is uniformly distributed throughout the coating is formed at another specific angle, which, due to the overlay effect of the two coatings, macroscopically exhibits the quarter phase retardation properties or broadband quarter phase retardation properties.

In some examples, at least one layer of transparent coating (not shown) may be formed on the surface of the phase retardation coating 300. The transparent coating protects the phase retardation coating 300 from scratches, isolates it from external moisture and chemicals, reduces surface reflection, etc. In addition, the formation method and material for the transparent coating may also refer to the aforementioned description regarding the formation of the transparent coating on one side of the linear polarizing coating 200.

In the embodiment shown in FIG. 3, the linear polarizing coating 200 and the phase retardation coating 300 are directly formed on two surfaces of the reflective polarizing film 100, respectively. The entire surface of the linear polarizing coating 200 facing the reflective polarizing film 100 is in direct contact with the reflective polarizing film 100, and the entire surface of the phase retardation coating 300 facing the reflective polarizing film 100 is in direct contact with the reflective polarizing film 100.

According to the embodiment of the present disclosure, since the phase retardation coating and the linear polarizing coating are directly formed on the surface of the reflective polarizing film, compared to a composite film in which the phase retardation film and the linear polarizing film are attached to the reflective polarizing film, the thickness is significantly reduced, and the number of internal interfaces is also reduced, so that it is possible to reduce light loss and suppress the appearance of stray light. In addition, in the optical polarizing device according to the embodiment of the present disclosure, there is no optical adhesive. There is no optical adhesive between three components respectively having a reflective polarization function, a phase retardation function and a linear polarization function, thus having better reliability and durability.

FIG. 4 is a schematic diagram of a cross section of an optical polarizing device according to some embodiments of the present disclosure. As shown in FIG. 4, a first undercoat 201 is provided between the reflective polarizing film 100 and the linear polarizing coating 200; and a second undercoat 301 is provided between the phase retardation coating 300 and the reflective polarizing film 100. For example, the first undercoat 201 and the second undercoat 301 may be made from materials with good adhesion properties, for example, may be formed by polyurethane, to enhance the adhesion of the reflective polarizing film 100 to the linear polarizing coating 200 and to the phase retardation coating 300. The first undercoat 201 may be formed, before the linear polarizing coating 200 is formed, on the surface of the reflective polarizing film 100 where the linear polarizing coating 200 is to be formed; and the second undercoat 301 may be formed, before the phase retardation coating 300 is formed, on the surface of the reflective polarizing film 100 where the phase retardation coating 300 is to be formed. It should be noted that although the first undercoat 201 and the second undercoat 301 herein can enhance the adhesion, they differ from the optical adhesive shown in the example of FIG. 2 in terms of the properties and effect. For example, the first undercoat 201 and the second undercoat 301 each have a thickness less than 0.5 micrometers. In some examples, the undercoat may have a thickness less than 0.1 micrometers. Such thickness of the undercoat is sufficient to enhance the adhesion between the above coating and the reflective polarizing film. In contrast, the optical adhesive in the example of FIG. 2 is intended to bond two films, and its thickness needs to be 5 micrometers or more to meet the requirements of bonding strength.

In addition, although the embodiment of FIG. 4 shows that the undercoats are provided between the reflective polarizing film 100 and the linear polarizing coating 200 and between the reflective polarizing film 100 and the phase retardation coating 300, but the embodiments of the present disclosure are not limited thereto. For example, the undercoat may only be provided between one of the linear polarizing coating 200 and the phase retardation coating 300 and the reflective polarizing film 100, and the other of the linear polarizing coating 200 and the phase retardation coating 300 is directly formed on the surface of the reflective polarizing film 100.

In addition to the first undercoat 201 and the second undercoat 301, other aspects according to the embodiment in FIG. 4 can be described with reference to any of the above embodiments, which will not be repeated herein.

FIG. 5 is a schematic diagram of a cross section of an optical polarizing device according to some embodiments of the present disclosure. In contrast to the embodiment shown in FIG. 4, in the embodiment shown in FIG. 5, the first undercoat 201 and the second undercoat 301 are both formed as island structures. That is, each undercoat includes a plurality of discretely distributed island structures. Between the island structures, the linear polarizing coating 200 and the phase retardation coating 300 may be in direct contact with the surfaces of the reflective polarizing film 100. Such island-structured undercoats may also enhance the adhesion. For example, the materials and thicknesses of the island-structured undercoats 201 and 301 can be described with reference to the related description in the embodiment shown in FIG. 4. It should be noted that the thickness of the island-structured undercoats 201 and 301 refers to the maximum dimension of each island structure perpendicular to the surface of the reflective polarizing film 100. The formation of the island structures is associated with the material that forms the undercoat and the thickness. When applying a small amount of the material that forms the undercoat, it is possible to form the island structures, rather than a continuous coating structure. Therefore, for example, the thickness of the island-structured undercoats 201 and 301 is also less than 0.5 micrometers.

Likewise, the island-structured undercoat may only be provided between one of the linear polarizing coating 200 and the phase retardation coating 300 and the reflective polarizing film 100, and the other of the linear polarizing coating 200 and the phase retardation coating 300 is directly formed on the surface of the reflective polarizing film 100. Alternatively, one of the undercoats on the two surfaces of the reflective polarizing film 100 is a continuous undercoat, and the other is an island-structured undercoat.

Therefore, according to the embodiment of the present disclosure, the distance between the at least one of the linear polarizing coating and the phase retardation coating and the surface of the reflective polarizing film being less than 0.5 micrometers may include the following situations: the entire surface of the coating facing the reflective polarizing film is in direct contact with the reflective polarizing film; the portions, between the island structures, of the surface of the coating facing the reflective polarizing film is in direct contact with the reflective polarizing film; and an intermediate layer (e.g., the undercoat as described above) with a thickness less than 0.5 micrometers is provided between the coating and the reflective polarizing film. It should be noted that the undercoat serving as an intermediate layer according to the embodiment of the present disclosure can enhance the adhesion of the linear polarizing coating and the phase retardation coating to the reflective polarizing film, but the intermediate layer is not limited to be in the form of a coating but can be selected from other suitable intermediate layers.

The linear polarizing coating and the phase retardation coating in the above embodiments are both formed on the reflective polarizing film in the form of coatings. However, in some examples, one of the coatings is located on a separately formed film, and then the film is attached to the reflective polarizing film.

According to some embodiments of the present disclosure, there is also provided a method for fabricating an optical polarizing device. For example, the method includes: preparing a reflective polarizing film; forming a linear polarizing coating on a surface of a first side of the reflective polarizing film; and forming a phase retardation coating on a surface of a second side of the reflective polarizing film opposite to the first side.

Before the linear polarizing coating and the phase retardation coating are formed, the surfaces of the reflective polarizing film may be treated. For example, plasma treatment or corona treatment may be performed to enhance the adhesion of the linear polarizing coating and the phase retardation coating to the reflective polarizing film or to promote the regular arrangement of the first repeating component.

Alternatively, as described above, a first undercoat 201 and/or a second undercoat 301 may be formed to enhance the adhesion of at least one of the linear polarizing coating and the phase retardation coating to the surface of the reflective polarizing film. When there is a continuous undercoat, the distance between the linear polarizing coating and/or the phase retardation coating and the reflective polarizing film is the thickness of the continuous undercoat. As can be seen from the above description of the thickness of the undercoat, the distance between the linear polarizing coating and/or the phase retardation coating and the reflective polarizing film is less than 0.5 micrometers. In some examples, the distance between the linear polarizing coating and/or the phase retardation coating and the reflective polarizing film is less than 0.1 micrometers.

In some examples, forming the linear polarizing coating includes: dissolving, in a liquid solvent, a first repeating component capable of forming a liquid crystal phase and a dichroic second repeating component to form a first coating solution; coating the surface of the first side of the reflective polarizing film with the first coating solution; and removing the liquid solvent, and causing the first repeating component and the second repeating component to be regularly arranged to form the linear polarizing coating.

In some examples, forming the phase retardation coating includes: dissolving, in a liquid solvent, a compound capable of forming a third repeating component that has a refractive index anisotropy to form a second coating solution; coating the surface of the second side of the reflective polarizing film with the second coating solution; and removing the liquid solvent, and forming the third repeating component in a regular arrangement to form the phase retardation coating.

In addition, in the optical polarizing device according to the embodiment of the present disclosure, since at least one of the linear polarizing coating and the phase retardation coating is formed on the surface of the reflective polarizing film, instead of attaching a separately formed linear polarizer and/or phase retarder to the surface of the reflective polarizing film, at least one of the two coatings formed in the optical polarizing device according to the present application may be formed by a roll-to-roll process, thereby greatly improving the production efficiency. In addition, the coatings may also be formed by a coating process, which process is relatively simple.

It should be noted that the materials of the coatings and the specific coating process in the method for fabricating an optical polarizing device according to the embodiments of the present disclosure can all refer to the above embodiments regarding the optical polarizing device, which will not be repeated herein.

According to an embodiment of the present disclosure, there is also provided a near-eye display apparatus, including: a display device, and an optical component arranged on a light-exiting side of the display device; the optical component includes at least one lens and an optical polarizing device formed on a surface of the at least one lens. For example, the near-eye display apparatus may be a virtual reality device.

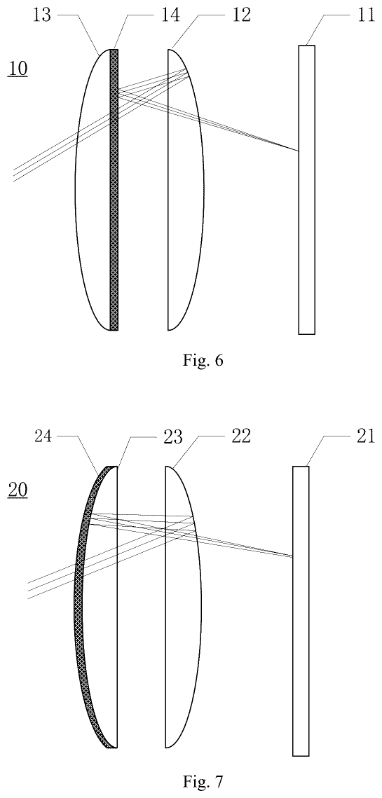

FIG. 6 is a schematic diagram of a structure of a near-eye display apparatus according to some embodiments of the present disclosure. For example, the near-eye display apparatus 10 includes a display device 11 and an optical component located on a light-exiting side (display side) of the display device 11. For example, the optical component includes a first lens 12 and a second lens 13, which are sequentially arranged in a light-exiting direction of the display device 11. On a surface of the second lens 13 facing the first lens 12, an optical polarizing device 14 according to any of the above embodiments is provided. For example, the surface of the second lens 13 facing the first lens 12 is a flat surface.

In the near-eye display apparatus 10, for example, a surface of the first lens 12 facing the display device 11 is a semi-transparent and semi-reflective surface, which may be formed by attachment or fabrication of a semi-transparent and semi-reflective film on the surface of the lens, but the embodiments of the present disclosure are not limited thereto. Right circularly polarized light emitted by the display device 11 passes through the semi-transparent and semi-reflective surface of the first lens 12, with the polarized state being unchanged, and then enters the phase retardation coating of the optical polarizing device 14 such that the right circularly polarized light is converted into linearly polarized light in the direction p. Then, the light is reflected for the first time at the reflective polarizing film of the optical polarizing device 14. The linearly p-polarized light is reflected and then passes through the phase retardation coating of the optical polarizing device 14 so as to be converted back into right circularly polarized light which is then reflected again at the semi-transparent and semi-reflective surface of the first lens 12. Due to half-wave loss, the reflected light is converted from right circularly polarized light to left circularly polarized light. The left circularly polarized light is then transmitted through the phase retardation coating of the optical polarizing device 14, and is converted into linearly s-polarized light which can be further transmitted through the reflective polarizing film of the optical polarizing device 14, and is further filtered by the linear polarizing coating of the optical polarizing device 14 to remove stray light before entering the human eye. It should be noted that the polarization direction or polarized state of the polarized light in the description is exemplary, and can be adjusted to any appropriate polarization direction or polarized state as desired.

FIG. 7 is a schematic diagram of a structure of another near-eye display apparatus according to some embodiments of the present disclosure. In contrast to the embodiment shown in FIG. 6, the optical polarizing device is formed on a curved surface of the lens. For example, the near-eye display apparatus 20 shown in FIG. 7 includes a display device 21 and an optical component located on a light-exiting side (display side) of the display device 21. For example, the optical component includes a first lens 22 and a second lens 23, which are sequentially arranged in a light-exiting direction of the display device 21. On the surface of the second lens 23 away from the first lens 22, an optical polarizing device 24 according to any of the above embodiments is provided. For example, the surface of the second lens 23 away from the first lens 22 is a curved surface.

The optical path of the near-eye display apparatus shown in FIG. 7 is similar to that of the near-eye display apparatus shown in FIG. 6, which will not be repeated herein.

It should be noted that the illustration for the near-eye display apparatus in FIGS. 6 and 7 is only illustrative. For example, the position in the optical polarizing device 14 or 24 where reflection occurs is at the reflective polarizing film thereof, but the reflection position is schematically shown at the surface of the optical polarizing device 14 or 24 for the ease of illustration. For example, in the near-eye display apparatuses 10 and 20, in both the optical polarizing devices 14 and 24, the sides on which the phase retardation coating is located respectively face the display devices 11 and 21. Therefore, in the embodiment shown in FIG. 6, the side of the optical polarizing device 14 on which the linear polarizing coating is provided is attached to the lens, whereas in the embodiment shown in FIG. 7, the side of the optical polarizing device 24 on which the phase retardation coating is provided is attached to the lens.

The embodiments shown in FIGS. 6 and 7 show the case where two lenses are provided, but the embodiments of the present disclosure are not limited thereto. The near-eye display apparatus according to the embodiments of the present disclosure may include one or three or more lenses, and the optical polarizing device is arranged on the surface of any one of the lenses. In addition, the near-eye display apparatus further includes a semi-transparent and semi-reflective surface which is provided between the display device and the optical polarizing device and which is spaced apart from the optical polarizing device.

In the near-eye display apparatus according to the embodiments of the present disclosure, the optical polarizing device may be arranged on a flat surface of a lens or on a curved surface of a lens. Since the optical polarizing device according to the embodiments of the present disclosure has a small thickness and few layers, even if the optical polarizing device is arranged on a curved surface of the lens, it can be well bonded to the curved surface. The other technical effects that can be achieved by the optical polarizing device itself as described above can also be embodied in the near-eye display apparatus.

The above description is merely exemplary implementations of the present invention and is not intended to limit the scope of protection of the present invention, and the scope of protection of the present invention is determined by the appended claims.

1. An optical polarizing device, comprising:
a reflective polarizing film;
a linear polarizing coating located on one side of the reflective polarizing film; and
a phase retardation coating located on the other side of the reflective polarizing film,
wherein a distance between at least one of the linear polarizing coating and the phase retardation coating and a surface of the reflective polarizing film is less than 0.5 micrometers.

2. The optical polarizing device according to claim 1, wherein the at least one of the linear polarizing coating and the phase retardation coating is in direct contact with the surface of the reflective polarizing film.

3. The optical polarizing device according to claim 1, wherein a continuous intermediate layer with a thickness less than 0.5 micrometers is provided between the at least one of the linear polarizing coating and the phase retardation coating and the surface of the reflective polarizing film.

4. The optical polarizing device according to claim 1, wherein an intermediate layer comprising a plurality of discretely distributed island structures is provided between the at least one of the linear polarizing coating and the phase retardation coating and the surface of the reflective polarizing film, and the at least one of the linear polarizing coating and the phase retardation coating is in direct contact with the surface of the reflective polarizing film between the plurality of island structures.

5. The optical polarizing device according to claim 1, wherein the linear polarizing coating has a thickness of 0.5 to 10 micrometers.

6. The optical polarizing device according to claim 1, wherein an angle between an optical axis of the linear polarizing coating and one of optical axes of the reflective polarizing film is less than 5 degrees so as to enable polarized light transmitted through the reflective polarizing film to be transmitted through the linear polarizing coating.

7. The optical polarizing device according to claim 1, wherein the linear polarizing coating comprises a regularly arrangeable first repeating component and a dichroic second repeating component on the surface of the reflective polarizing film.

8. The optical polarizing device according to claim 7, wherein the first repeating component and the second repeating component each comprise at least one of a molecule, a molecular fragment and a group.

9. The optical polarizing device according to claim 8, wherein the first repeating component comprises a lyotropic liquid crystal molecule, molecular fragment or group, and the second repeating component comprises at least one of iodine, an azo dye, a polycyclic dye, an anthraquinone dye, triphenyldiazine and a derivative thereof, and monomethine and polymethine compounds.

10. The optical polarizing device according to claim 8, wherein the first repeating component and the second repeating component are two molecular fragments of one molecule.

11. The optical polarizing device according to claim 1, wherein the phase retardation coating has a thickness of 0.5 to 10 micrometers.

12. The optical polarizing device according to claim 1, wherein the phase retardation coating comprises a regularly arrangeable third repeating component on the surface of the reflective polarizing film, and the third repeating component has a refractive index anisotropy.

13. The optical polarizing device according to claim 1, wherein the phase retardation coating is a quarter-wave phase retardation coating.

14. The optical polarizing device according to claim 1, further comprising a transparent protective layer formed on at least one of a side of the linear polarizing coating away from the reflective polarizing film and a side of the phase retardation coating away from the reflective polarizing film.

15. A method for fabricating an optical polarizing device, comprising:
preparing a reflective polarizing film;
forming a linear polarizing coating on a surface of a first side of the reflective polarizing film; and
forming a phase retardation coating on a surface of a second side of the reflective polarizing film opposite to the first side,
wherein a distance between at least one of the linear polarizing coating and the phase retardation coating and a surface of the reflective polarizing film is less than 0.5 micrometers.

16. The method according to claim 15, further comprising at least one of the following steps:
prior to forming the linear polarizing coating, forming, on the surface of the first side of the reflective polarizing film, a first intermediate layer that has a thickness less than 0.5 micrometers or is in the form of discretely distributed islands; and
prior to forming the phase retardation coating, forming, on the surface of the second side of the reflective polarizing film, a second intermediate layer that has a thickness less than 0.5 micrometers or is in the form of discretely distributed islands.

17. The method according to claim 15, wherein forming the linear polarizing coating comprises:
dissolving, in a liquid solvent, a first repeating component capable of forming a liquid crystal phase and a dichroic second repeating component to form a first coating solution;
coating the surface of the first side of the reflective polarizing film with the first coating solution; and
removing the liquid solvent, and causing the first repeating component and the second repeating component to be regularly arranged to form the linear polarizing coating.

18. The method according to claim 15, wherein forming the phase retardation coating comprises:
dissolving, in a liquid solvent, a compound capable of forming a third repeating component that has a refractive index anisotropy to form a second coating solution;
coating the surface of the second side of the reflective polarizing film with the second coating solution; and
removing the liquid solvent, and forming the third repeating component in a regular arrangement to form the phase retardation coating.

19. A near-eye display apparatus, comprising:
a display device, and an optical component arranged on a light-exiting side of the display device, wherein the optical component comprises at least one lens and an optical polarizing device formed on a surface of the at least one lens, the optical polarizing device comprises:
a reflective polarizing film;
a linear polarizing coating located on one side of the reflective polarizing film; and
a phase retardation coating located on the other side of the reflective polarizing film,
wherein a distance between at least one of the linear polarizing coating and the phase retardation coating and a surface of the reflective polarizing film is less than 0.5 micrometers.

20. The near-eye display apparatus according to claim 19, wherein the surface of the at least one lens that is provided with the optical polarizing device is a curved surface.
